(19) United States
(12) Patent Application Publication
(10) Pub. No.: US 2008/0208914 A1
(43) Pub. Date: Aug. 28, 2008

(54) CENTRALIZED MINING OF REMOTE MEDICAL RECORDS DATABASES

(75) Inventor: Girish Kumar Navani, Shrewsbury, MA (US)

Correspondence Address: POWELL GOLDSTEIN LLP, 901 NEW YORK AVENUE, N.W., 3RD FLOOR, WASHINGTON, DC, 20001-4413, US

(73) Assignee: ECLINICALWORKS LLC, Westborough, MA (US)

(21) Appl. No.: 12/037,260

(22) Filed: Feb. 26, 2008

Related U.S. Application Data
(60) Provisional application No. 60/951,308, filed on Jul. 23, 2007.
(60) Provisional application No. 60/891,837, filed on Feb. 27, 2007.

(51) Int. Cl. G06F 17/30

(52) U.S. Cl. 707/104.1; 707/E17.009

(57) ABSTRACT

In accordance with an embodiment, a remote logical interface for mining medical data records comprises a data processor for receiving input of a selection of criteria for a medical records query, a database of medical records, responsive to a query, for outputting patient medical record data responsive to the query, and a plurality of operations including a means of combining a first and second query and a means of providing medical data not meeting the first and second query. Such remote logical interfaces may be actuated from a centralized location via an authorized user access portal. The electronic medical records query may utilize a plurality of filters among the following: demographics, vitals, laboratories, ICD codes, CPT codes, prescriptions, alerts, medical history, immunizations and encounters/visits among other filters. In one embodiment, the result of a series of queries may be output to the centralized location of a central database for various purposes including the identification of an outbreak of an epidemic in a geographic region. In reverse, a remote logical interface embodiment may comprise a patient portal for posting personalized patient alerts regarding, for example, medical risks associated with taking a given medication or having received a bad vaccination lot.

This application claims priority to U.S. Provisional Patent Application Ser. No. 60/951,308, filed Jul. 23, 2007, which claims priority to U.S. Provisional Patent Application Ser. No. 60/891,837, filed Feb. 27, 2007, of Girish Navani which application is incorporated herein by reference in its entirety.

### TECHNICAL FIELD

Aspects of embodiments of centralized mining relate to the technical field of data processing apparatus and computer software for providing a centralized or remotely accessible logical interface to mine medical patient records at remote locations of databases or, vice versa, the logical interface to a patient database at a local site such as a physician's office or hospital may periodically report to a centralized location certain summary data required for preventive, screening and emergency purposes. As a result of having a logical interface for mining patient data records at each remote database or periodic reporting to a centralized database, medical statistics may be gathered and stored at the central database, patient or physician communications may be generated automatically from a central location, for example, medical alerts and the like may be transmitted and generated at the remote location or from the centralized location to patients via a secure patient portal at each remote database or via other broadcast announcement. Moreover, the centralized medical records data mining has application for many other purposes only limited by the imagination.

### BACKGROUND OF THE INVENTION

Electronic medical record hardware and related software systems are known. In deed, the assignee of the present invention, eClinicalWorks, has been in the business of developing and offering for sale such systems for many years. U.S. Pat. No. 6,684,276 issued to Walker et al. describes a patient encounter electronic medical record system, method and computer product. The product includes pre-populated, diagnostic templates, selective, specialty-specific master databases and templates to achieve comprehensive, accurate and compliant medical documentation that captures patient data concurrently with a clinical patient encounter system. Referring to FIG. 6, for example, there is shown a series of patients 1-6 processed over time demonstrating a productivity flow. FIGS. 7A-7B provides a system process flow diagram including data entry. By way of example, FIG. 13A shows a “present history” of a “medial meniscus tear” for a 25 year old man. ICD (diagnosis) codes are shown in Table 2 for “pain knee” and the computer system 1201 may include special purpose logic devices. In the description of FIG. 11 is included a “drilldown logic feature” to output a screen of greater anatomical detail.

A patient-controlled medical information system and method are disclosed in U.S. Pat. No. 6,988,075 to Hacker. Patient medical records are centrally stored on a database that may be remotely accessed by patients. Referring to FIG. 1, there is shown a patient 101 who registers with a service to have their medical records stored electronically on a medical information database 110. In one embodiment, email may notify the patient of an impending appointment. With the patient's permission, the system can be used by a medical researcher.

Methods and apparatus for early detection of health-related events in a population are described by U.S. Pat. No. 7,024,370 to Epler et al. Sets of specific emergency room patient information may be captured from a subset of a population as the patient information is first electronically entered into an electronic medical record. For example, reference should be made to FIG. 2, step 11 and its attendant description. An alert may then be reported to a health official or government authority such as the Center for Disease Control (CDC).

Medical records, documentation, tracking and order entry are described by U.S. Pat. No. 7,076,436 issued to Ross et al. A feature of the '436 disclosure is data entry whereby dictation may be automatically input and parsed and incorporate prephrased text. A plurality of modules of the system include, for example, a security validation module for users, a tracking module, a master patient module, an advanced cardiac life support module, a laceration module, a utilities module, a transcript text analysis module and an interface module among other modules.

U.S. Pat. No. 7,092,891 describes a secure medical records maintenance system involving a first server for storing patient identification information by patient identification number and a second server for storing such records by medical record identification numbers. The latter may intentionally not be correlated to the former for security purposes without a special correlation table.

U.S. Pat. No. 7,133,937 relates to input devices for entering data into an electronic medical record. FIG. 3 illustrates a template and pen-like input device for data entry and, according to FIG. 4, may further incorporate condensed microphones. A stylus according to FIG. 5 may incorporate a microphone activation button and microphone into the stylus for also writing on a touchscreen.

A web-based data entry system and method of generating medical records is described by US Patent Application Publication No. 2006/0116908. Clinical, tree-like pathways are traversed as data describing a patient's condition is entered during a clinical examination of a patient. At a node, a physician may be prompted for additional health information to aid in the diagnosis/treatment. For example, per FIG. 3, an anatomical region leads to long bones, a right long bone, office x-rays, a contusion, no injury and follow-up, for example, leading to a “resolved” state or “not improving.”

A method, system, and computer-readable medium for providing a patient electronic medical record with an improved timeline is discussed in US Patent Application Publication 2006/0265249 to Follis et al. Referring to FIG. 2, there is shown a Bill K. Jones, a 51 year old male and an associated date line display from 1990 through 2003. A number of sections appear on a y-axis, for example, documents, past surgical history, medical imaging, PSA/labs, medications and the like. FIGS. 27-61 illustrate exemplary user interface screens for creating office visit notes for inclusion in a patient's electronic medical record. Specific results, for example, of a urinalysis may be displayed per FIG. 82.

The above-identified US patents and published applications should be deemed to be incorporated herein by reference as to their entire respective contents.

### SUMMARY OF ASPECTS OF PREFERRED EMBODIMENTS

In accordance with an embodiment, a logical interface for mining medical data records comprises a data processor for receiving input of a selection of criteria for a medical records query, a database of medical records, responsive to a query, for outputting patient medical record data responsive to the query, and a plurality of operations including a means of combining a first and second query and a means of providing medical data not meeting the first and second query. The query may utilize a plurality of filters among the following: demographics, vitals, laboratories, ICD codes, CPT codes, prescriptions, alerts, medical history, immunizations and encounters/visits (among other filters). Demographics information may include personal or family income level, age, sex, address and the like. Logical “OR” queries for a given filter may be separated by commas denoting their logical “OR”'ing. Combining queries of different filters results in a logical “AND.” The “NOT” may, for example, result in patients who have not had a physical within a predetermined period of time or have not been vaccinated for the flu and are within an age group exceeding 65 years of age. In one embodiment, the result of a series of queries may be remotely queried by authorized users and output to a central database for various purposes including the identification of an outbreak of an epidemic in a geographic region. In an alternative embodiment, a local database of patients may be mined periodically for predetermined data respecting preventive care, screening and successful treatment rates of demographic profiles such as low income individuals ands sent to a centralized location, for example, monthly or quarterly. The centralized location may be a local, state or federal government location or that of an insurance carrier. These agencies may then determine relative success rates among hospitals, physician groups and the like of screening for treatment, preventive treatment and treatment of chronic patients and the relative success rates. In this manner, the centralized agency may provide feedback to the physician group, hospital or directly to a given patient about their relative progress when compared with others within their demographic. In another embodiment, an embodiment may comprise a patient portal for posting personalized patient alerts regarding, for example, medical risks associated with taking a given medication or having received a given vaccination or course of treatment.

These and other features of the logical interface and centralized mining of remote patient records or automatic reporting of summary data by a remote patient database will become clear from reading the following detailed description of an embodiment with reference to the drawings.

### BRIEF DESCRIPTION OF THE DRAWINGS

FIG. 1 is a general system description depicting four functions including schedule, prescribe, chart and charge functions that may be provided by one or more electronic medical records computer software systems.

FIG. 2 shows a typical doctor's office system 201 which may include data input and output locations for medical patient data of a database managed by a plurality of data entry terminals, output devices and, for example, personal computers coupled to a main processor server and database. The system 201 may be redundant for disaster recovery purposes and maintained at a plurality of locations in a secure manner and in communication with other offices and one or more central locations.

FIG. 3 is a schematic block diagram of the functionality of the electronic medical records software of one embodiment showing a registry function and a plurality of exemplary data including demographic, vitals, laboratories, ICD, CPT, prescription, alert, medical history, immunization and encounters/visits which may be utilized as filters in a query/run subset/run subset (not) Boolean mining of the exemplary data.

FIG. 4 is a depiction of an EMR registry module of FIG. 3 showing available connectivity for outputting subset data in a secure manner for external purposes such as federal, state and private research purposes; alternatively, the EMR registry module may be accessed from such external agencies for, for example, confidential patient alerts.

FIGS. 5 represents a screen shot of a Vitals Button with “Migrate Vitals” button 501 and a plurality of logical interfaces—Save Queries, Run Subset (NOT), Run Subset and Run New which comprise a registry function.

FIG. 6 represents a screen shot for assessment notes, for example, for code 369.11, of a particular patient.

FIG. 7 represents a screen shot for CPT Codes.

FIG. 8 represents a screen shot for a CPT Groups (pop-up).

FIG. 9 represents a screen shot for selecting a Drug Class.

FIG. 10 represents a screen shot for a drug class (popup).

FIG. 11 represents a screen shot for selecting a prescription by Drug codes.

FIG. 12 represents a screen shot for drug codes popup.

FIG. 13 is a screen shot representing a short hand for providing durations such as 3 D (3 days) or 2 Y (2 years).

FIG. 14 is a screen shot for selecting assessments among ICD codes where a first step may comprise selecting an assessment category or group such as cardiology 1400.

FIG. 15 is a screen shot for selecting assessments among ICD Codes where alternatively a code such as 3^{rd} degree sunburn 1410 may be picked directly and not by category.

FIG. 16 is a screen shot representing an ICD Groups popup for Cardio, for example for cardiology 1400.

FIG. 17 is a screen shot representing a laboratories list which may include imagery.

FIG. 18 is a screen shot representing Lot Number Options for, for example, vaccines.

FIG. 19 is a screen shot representing what may be lower buttons, for example, new appointment button 1910 for scheduling a new appointment.

FIG. 20 is a screen shot for a Medical History list such as an abscess 2010.

FIG. 21 is a screen shot for a Save Registry Report for saving a report prepared using a logical interface for logically combining queries of a patient database 206.

FIG. 22 is a screen shot for Standard Buttons for the registry function showing the registry buttons save queries, run subset (not), run subset and run new.

FIG. 23 represents a locus of a catastrophe and an application for centralized mining of remote databases to control/monitor a response to the catastrophe.

FIG. 24 provides a system block diagram of a centralized system including a centralized database for controlling recovery from a catastrophe.

FIG. 25 provides a typical flowchart for the system of FIG. 24 controlling a catastrophe response.

FIG. 26 provides a flowchart for a method of providing authorized user access selectively to authorized users comprising physicians, agencies, insurance companies and others.

### DETAILED DESCRIPTION OF EMBODIMENTS

Electronic patient medical record software is known for many purposes. For example, one may record patient appointments with doctors or other medical practitioners. Patient data may be automatically entered from a questionnaire, scanned into a system electronically or manually entered for demographic, patient history data and the like. Herein, such a system may be referred to as a front-office management system. In a mid-office management system, medical history records data may be recorded into a patient database as a doctor interviews a patient. Laboratory test data, patient image data, treatment data and prescription data may be merged into a patient database from locations internal or external to the primary care provider's offices. Prescriptions may be coordinated with drug and medical device outlets, and patient billing and medical insurance requirements may be met through software interaction with a patient database and the like. In a back office management system, billing and insurance coordination is provided so that patients may be properly billed according to standard insurance coding. Moreover, an insurance company (or federal, state or local agency) may receive periodic reports about their insured patient population, rates of success in treatment and chronic condition preventive and disease screening care.

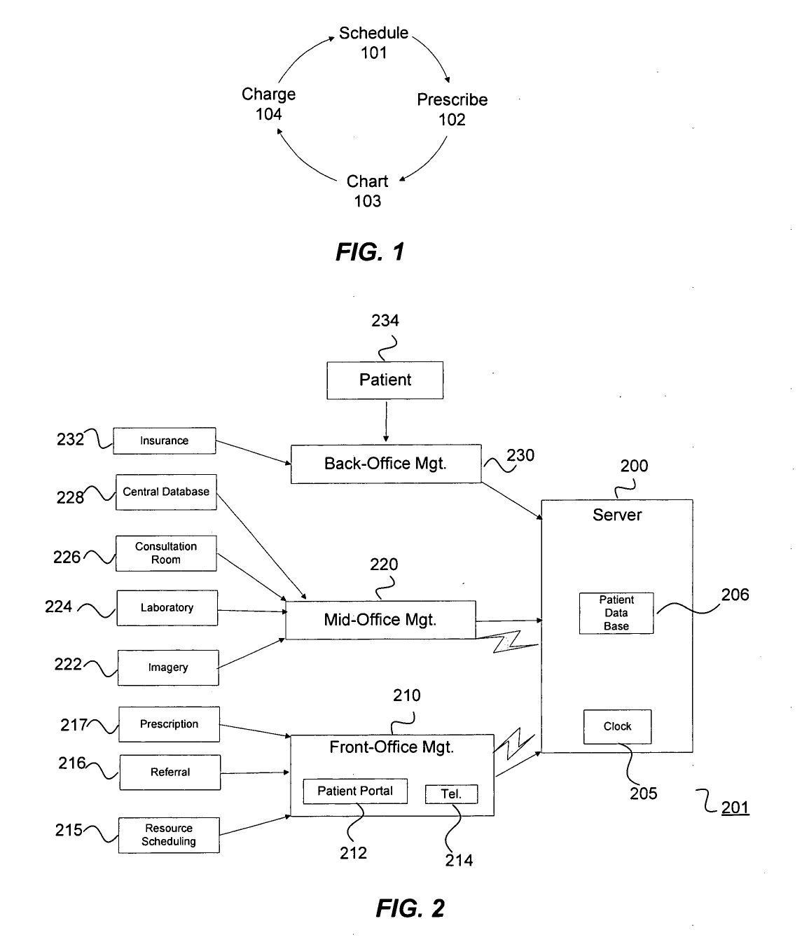

Referring to FIG. 1, there is shown a circular chart showing the purposes to which electronic medical records software systems may be applied. The chart comprises schedule 101, prescribe 102, chart 103 and charge 104. While a circular line is shown connecting these functions, it should not be inferred that these functions are performed in a particular order. In deed, a chart may be prepared with at least demographic information for a particular patient before a prescription is written for the patient. Nevertheless, the circular chart suggests that the process is iterative and must operate in real time. For example, illnesses, broken legs, telephone calls to schedule appointments, no shows for appointments and the like are real-time events which are unpredictable to the extent, for example, that known telecommunications busy hours are measurable phenomenon and so some prediction for patient calling patterns may be made.

Each purpose of schedule 101, prescribe 102, chart 103 and charge 104 will now be briefly explained. Schedule 101 refers to the start of a patient intake process that may be provided by an electronic medical records software system. A referral may be made by one group of doctors to another, for example, from a primary care provider to an orthopedic group in the event the patient of a primary care provider suffers a broken bone. The scheduling of an appointment may be precipitated not by a referring physician but by the patient themselves calling the primary care provider or a specialist's office. This scheduling software may also be referred to as front office management software and may be typically separately provided from other software functionality. The physician(s) or their assistant(s) may manage the physician's busy schedule electronically by creating, modifying and canceling appointments. The referral itself and the referring physician may be managed and their contact information and input collected. Access to patient records must typically be provided in a secure manner; patient privacy is very important. Via the input provided by the referral or directly by the new patient, patient demographics may be managed effectively. In managed care situations such as local, state and federally supported preventive, screening and treatment programs, demographics may include but not be limited to including sex, age, level of income, living conditions, employment and address data among other demographic data useful for summary data reporting as will be further described herein.

A patient appointment may be appropriately sized for the anticipated need. For example, the broken leg may have certain units of time associated with the initial consultation, diagnosis and prescription of certain imaging and potentially the scheduling of certain resources for surgery and the like. These all may be entered via scheduling software into a database. On the other hand, for example, a complete physical for a patient may have longer or shorter units of time allocated to the physical which may include separate allocations of time required for in the office collection of blood and urine samples. The patient's in office physician visit may be monitored as individual time slots from the time the patient enters the office until the time the patient leaves.

In accordance with yet other functionality there may be a prescription functionality 102 associated with electronics medical records software. The physician may request x-rays, MRI scans and other imagery, blood testing, urinalysis and other tests, issue drug and medical device prescriptions and the like. There may be a refill charge billed to the patient, for example, in the instance of a requested refill if connected to a charge functionality 104. The results need to be received and merged with the patient records database. As suggested above, sample collection such as blood and urine may be collected during the visit, and the visit scheduled to allow sufficient time for collection. The laboratory results of analysis may be performed locally, for example, if the physician group comprises a hospital or office with internal laboratory facilities or the laboratory or imaging work may be performed elsewhere upon samples taken in the physician's offices.

During the patient visit, there is a charting functionality 103 that may be associated with electronic medical records software. Charting may begin with a patient filling out a questionnaire or providing demographic and prior medical history data by electronic data entry. Data may be transferred in a secure manner from a primary care provider to a referred to physician for populating their database. The questionnaire may be in the form of a checklist of bubbles filled in by special number two pencil and electronically scored. Charting by a physician or nurse may occur via a wireless IEEE 802.11 LAN or MAN via a hand-held wireless terminal such as personal computing device from palm-size upwards. The physician or other care provider, at a patient meeting or during the office visit, may create or update the chart and the time of service from start time to end time for the portion of the appointment for chart consultation recorded. For example, the patient may be taken to a consultation room from a reception area. The physician may bring a PocketPC or TabletPC, a smaller iPhone, personal data assistant (PDA or other portable wireless device) with them to meet the patient in the consultation room. The physician or other care provider may directly enter chart, such as demographic and diagnostic, data, vitals such as temperature, blood pressure and the like into an electronic patient chart via a personal computer or the wireless device and the time of day and date recorded automatically for the given patient.

In deed, the maintenance of an electronic patient record and chart may be referred to as a mid-office management computer software system, designed to permit the physician, nurse or other care provider access to and permission to input demographic, prescription, test, treatment and other patient data from the doctor's office, hospital or from their home or from the patient's home remotely via a secure remote data port or wireless data entry.

A fourth functionality of an electronic medical records software system may be a charge function 104. This function may also be referred to as a back-office management function of verifying patient eligibility, making insurance claims for patient visits, recording receipt of payments from insurance providers and patients and, for example, determining office visit copayment. After the visit, claims may be electronically submitted to insurance carriers for the patient. The back-office component may communicate with payers to confirm eligibility of the patient to receive the care and treatment provided and thus permit feedback to the patient if or when the patient is unsatisfied with their bill or insurance coverage. A further functionality, not shown in FIG. 1, may be an automatic reporting/feedback system with a central agency or insurance carrier application software/database. As will be described herein, summary data about a given patient population demographic may be provided (such as all patients insured by a given insurance carrier or all patients receiving care within a patient demographic covered by a local, state or federal agency supporting the care of the demographic such as an indigent population.

As discussed above, some entities provide the component functionality of FIG. 1 in piece part. For example, front office management is provided by one software package running on one computer and mid-office management runs on a second computer while back-office management software runs on yet another computer.

Embodiments according to FIG. 2 et seq. provide an integrated solution to the preservation and mining of medical records which, on the one hand, preserve the confidences of electronic patient medical records but on the other hand recognize the value of patient record databases in, for example, medical studies to evaluate the success of courses of treatment (for example, insurance carriers deciding whether to cover a given procedure depending on a new, “untested” course of treatment, medication or procedure) and the ability to predict onsets of epidemics such as a bird flu or for other purposes including emergency situations such as terrorist acts, hurricanes, fires, releases of poisonous gas and the like. All four functions of schedule, prescribe, chart and charge of FIG. 1 desirably are performed by one software implementation and include a data patient registry feature at each electronic medical record location to query practice databases for highly specific patient information. The registry feature may be remotely triggered by authorized users and may be applied to periodically report summary mined data to a central site.

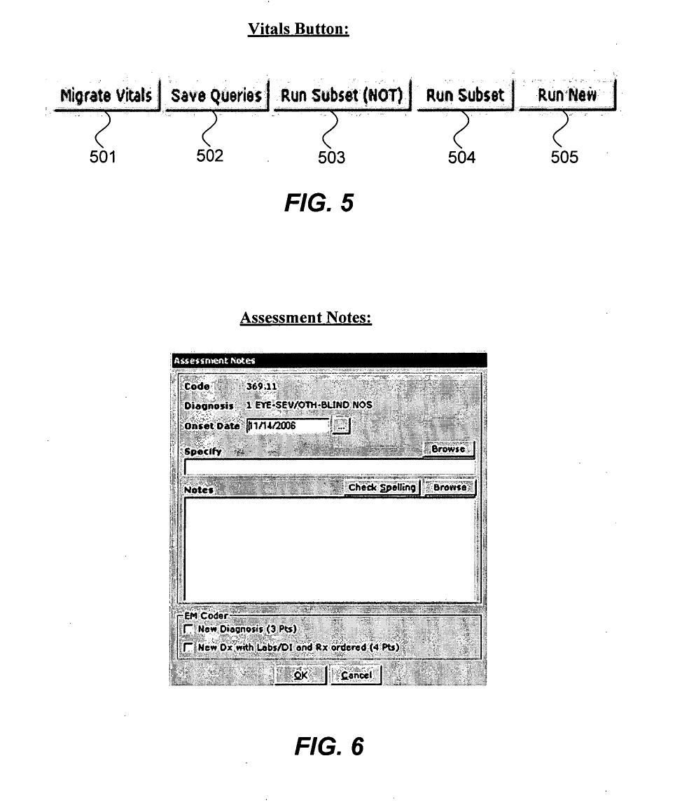

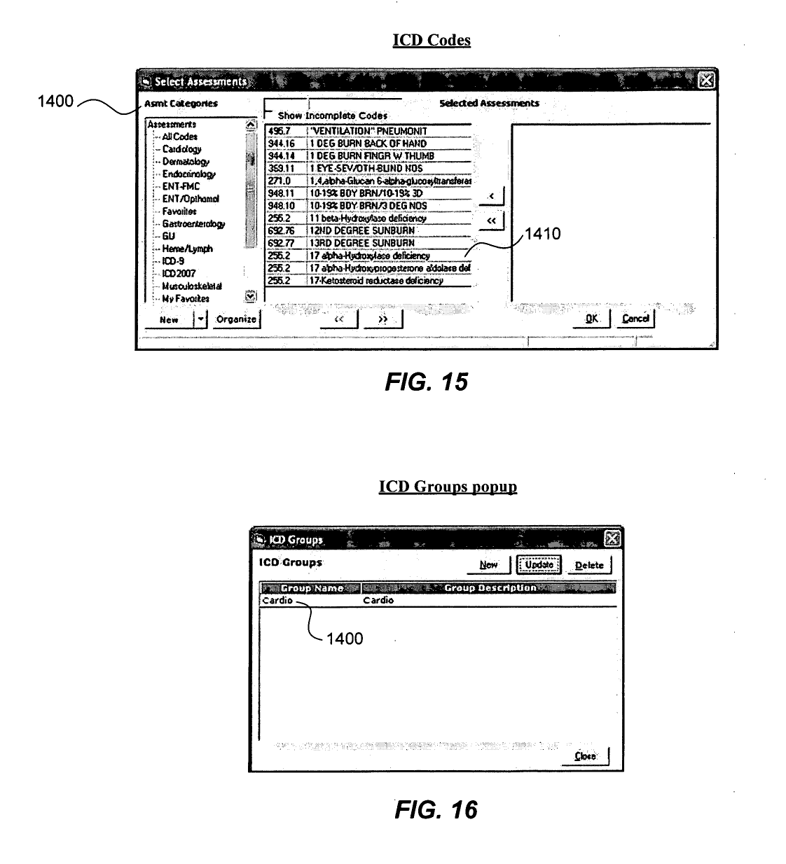

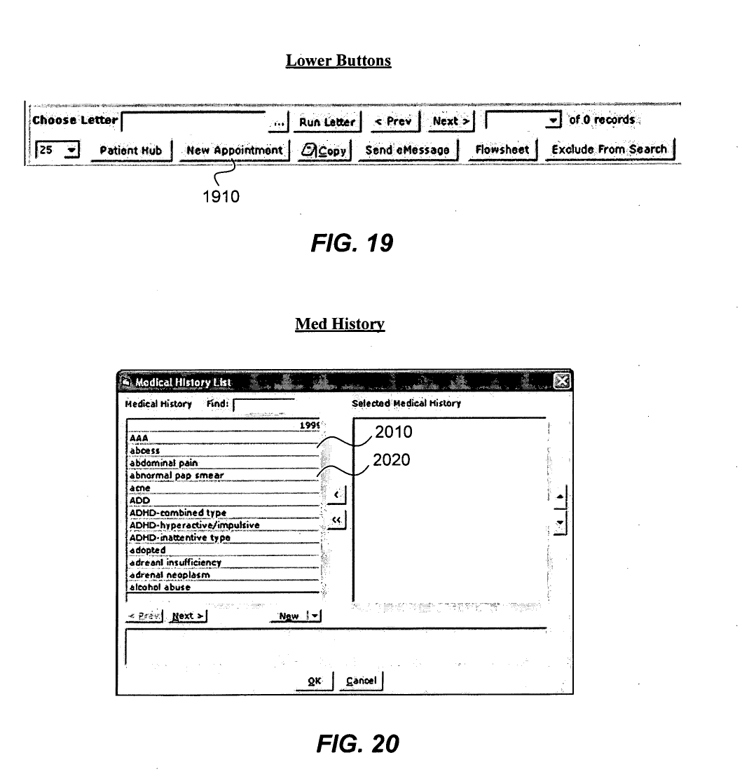

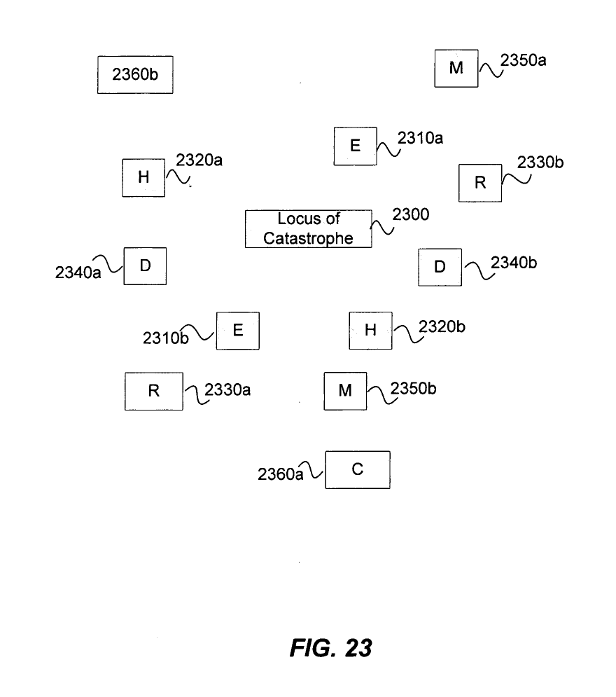

An embodiment of apparatus and a method for logically interfacing a patient medical record database will now be described with reference to FIGS. 1-4 and exemplary screen shots FIGS. 5-22 of electronic medical records interface software according to one embodiment. An emergency situation application is described by FIGS. 23-25.

The typical doctor's office maintains a front desk and reception area and an external interface to the patient, typically a telephone interface. FIG. 1, as described above, describes functionality performed within a doctor's offices from schedule 101 to charge 104. As explained above, the patient is involved at each level but, in the prior art, treated differently by different automated systems.

Referring to FIG. 2, a medical system 201 is shown with external interfaces to, for example, insurance 232, a patient 234, prescription 217, laboratory 224, imaging systems 222 and a referring physician 216 among other external entities.

There is shown a front office management module 210 of an electronic medical records computer software system application of a server 200 of an embodiment. Server 200 may be a Sun workstation server or a personal computer. Preferably, and for disaster recovery, the server 200 may be redundant but is shown as one unit for simplicity. The front office interface 210 to the patient occurs in many ways, typically by phone 214 and in person in a reception area of an office. In one embodiment, there is a secure patient portal 212 via the world wide web whereby a patient may obtain even greater access than via telephone 214 as will be further explained below.

Also in FIG. 2, there are shown a mid-office management module 220 and a back-office management module 230 likewise serving as modules of computer software of server 200. The mid-office management module 220 is connected, for example, via wireless means, for example, IEEE 802.11 wireless LAN/MAN, to, for example, consultation rooms where a physician or other care provider may take and record medical history, vitals and the like as will be described herein for storage in database 206. Laboratory results (and time of day and date automatically recorded), chart data (from consultation room 226, for example) may be input from laboratory 224 and imagery input from imagery (Xray, MRI, etc) 222 to database 206 and clocked in real-time by time clock 205 by time and date.

Finally, in FIG. 2, there is shown a back-office management component 230. Typically, as the patient first enters the office, their insurance card is presented and may be entered at the front office management system 210 at initial patient contact. A given insurance carrier may have a particular relationship with a given physician group or hospital and reach carrier may have special requirements as to what treatments and the like are covered and how by a given policy. Similarly, the indigent may have no coverage at all and rely on local, state or federal healthcare to provide coverage for their needs. In connection with each such carrier or agency, certain demographic information may be required such as income level for storage in an EMR database for that patient. Behind the scenes, the back-office management system 230 may verify insurance coverage, co-pay procedures and the like with insurance company 232 or a supporting agency and the patient may be requested to pay the appropriate co-pay amount and receive a well-documented bill showing a correct accounting of their status with their insurance carrier. On the other hand, a procedure recommended for a patient 234 may be refused by the carrier, for example, because the insurance carrier believes the procedure is not warranted for whatever reason. Then, the patient 234 may be advised of the cost of the procedure, its benefits and possible side effects via a patient portal 212 or in person. According to one aspect and embodiment, data on the uncovered procedure, preventive measure, medication and the like may be requested and reported in summary form on a periodic basis to the carrier or agency such that the agency may determine a probability of success and subsequently approve a successful previously uncovered treatment. Moreover, data may be collected if a suggested course of treatment or preventive care is refused by a patient within a given demographic or income level so that an insurance carrier or agency may attempt to educate that given demographic as to the desirability of treatment and/or monitor and correlate patient education and advertising programs with acceptance of treatment and increases in requests for treatment.

According to FIG. 1, the patient is involved in all phases of a process of medical service including scheduling 101, prescribing 102, charting 103 and charging 104. As can be seen from an embodiment according to FIG. 2, the patient is indeed involved in all phases of his processing through front office to back office, and the embodiment of FIG. 2 is an improvement over systems which treat front office scheduling as a separate computer software system from, for example, back office processing systems.

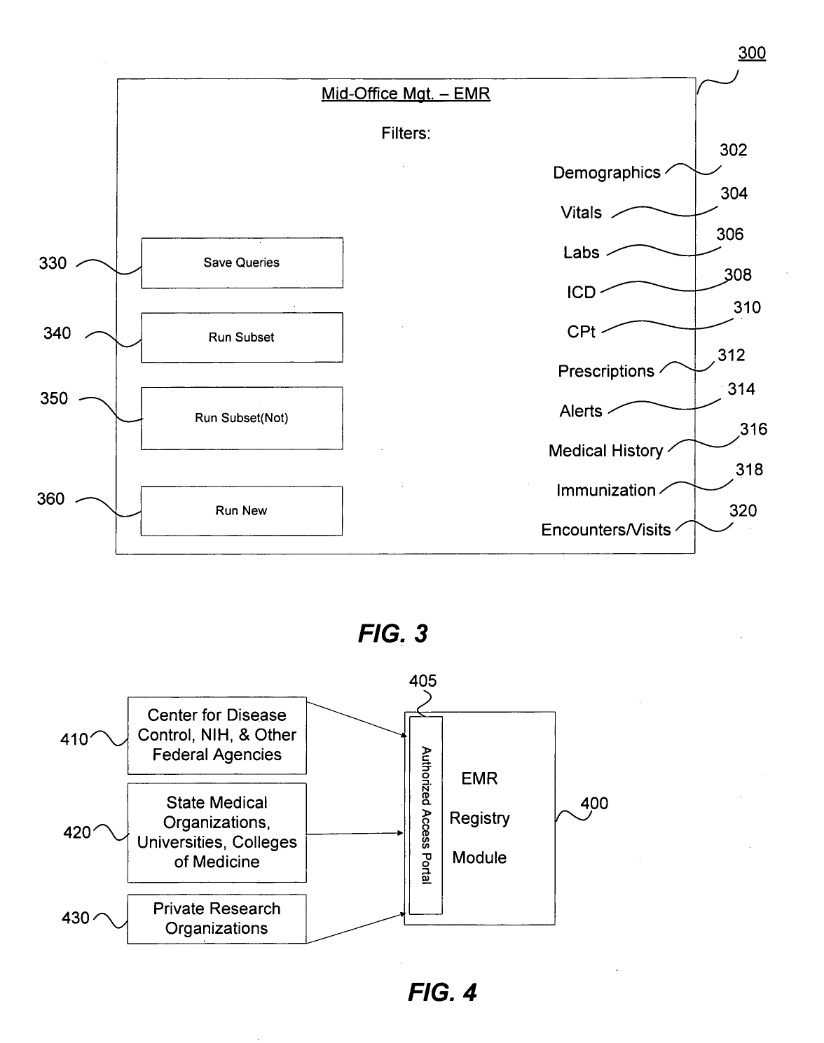

As soon as a patient calls a front office of a doctor's office, a receptionist takes the call via telephone 214 and begins interfacing with a system according to FIG. 2. As soon as a patient enters a doctor's office and signs in, the server 200 may record the time of day and date by clock 205 in database 206 so that the patient may be efficiently serviced during their visit and leave, hopefully, with a feeling of time well spent. FIG. 2 provides an integrated service embodiment for providing full services to a patient and, as will be described in greater detail in FIGS. 3-4, the medical records of a patient, in combination or singly, may provide a wealth of data which may be mined by the specialist or the primary care physician or by organizations external to either. In the specification, the primary care physician may be referred to as an example of a referring physician who in turn may refer a patient to a specialist for providing special services in accordance with a medical specialty. Such examples should not be deemed to be limiting in scope to other obvious possibilities such as when a cardiologist confers with another specialist such as a pediatrician on a diagnosis of a rare congenital heart defect of a child.

Referring again to FIG. 2, a front office module 210 of a medical record software system 200 may provide a patient portal 212 for, for example, an internet or world wide web interface to the patient 234. The patient 234 may securely access their own records after electronic signature or patient identification is satisfactorily provided to the system 201. Moreover, patient privacy is supported in all links between the patient 234 and the database 206 or their access to any resources 215 or prescription scheduling 217. Patient privacy is also supported in any access by external authorized users such as physicians within or outside an EMR group, insurance carriers and other external agencies. The patient 234 may schedule appointments or telephone consultation sessions or schedule resources through the patient portal 212 efficiently and securely. The patient 234 may order prescription refills 217, modify or cancel an existing appointment, typically with physician approval. In deed, through a wireless connection, the physician (not shown in FIG. 2 but who may access or be accessed by any of modules 210, 220, 230) may be alerted to the request for a refill 217 and immediately grant the prescription refill with a practically immediate output facsimile or other notification to a pharmacy of the patient's choice via prescription link 217. Subsequently, herein, in connection with FIG. 4 will be introduced an authorized user portal 405 whereby, for example, a physician, an insurance carrier or external agency may obtain remote access to the systems of FIGS. 1-4 and access to data limited according to need and patient privacy legal requirements. For example, data may be provided periodically in summary form to an insurance carrier for only those patients insured by that carrier. Similarly, a state or federal agency funding certain experimental procedures or treatments or healthcare for the indigent may receive summary data printouts for the experimental procedure or according to income level on a periodic, such as monthly, basis. A patient may have a patient screen and rights to access information that are considerably less than those of a physican or an external insurance carrier or an agency using a portal 405. Different security levels for access may be provided for a hierarchy of authorized users such as all the possible users shown and discussed in connection with FIGS. 1-4. For example, a physician may retrieve prescription requests for his patients, write prescriptions and update database 206 while a patient may merely access their personal medical history, make a request, schedule an appointment and the like through patient portal 212. Similarly, the patient 234 may interface with a front office management module 210 by telephone 214 and conduct much of the same business but utilizing the time and expense of a receptionist in a conventional manner. Consequently, a patient portal 212 can save a group of physicians time and money while providing increased access, for example, to resource scheduling 215 (make surgical room, laboratory or imaging appointments) not typically accessible through a receptionist.

A registry feature is provided via mid-office management 220 or other component of system 201 for mining database 206. Queries may identify, for example, certain vital symptoms that have been detected in a number of patients recently visiting a given office and provided via link 228 to a central database 228 for, for example, the Center for Disease Control. The Center for Disease Control, having collected data on the same symptoms from a number of offices in a given region, for example, may be able to identify the onset of an epidemic. As will be discussed subsequently herein, an authorized user of the CDC may access a registry application and query database 206 for certain symptoms, vitals and/or laboratory results expected of a given disease for all patients in database 206, for example, by special password access and encrypted data retrieval. The CDC may receive specialized summary data reports for given diseases under study on a periodic basis and receive data on individuals refusing treatment, for example, for such contagious diseases as AIDS. In reverse, a medical alert may issue via central database 228 and be received at a mid-office component 220 or other component of system 201. A physician group may be alerted of their success rate in comparison with other physician groups or hospitals similarly situated. Moreover, the front-office management component may issue patient alerts through the patient portal 212 or via an automatic telephone system 214 for repeatedly attempting to reach a patient 234 of the system 201 warning that the patient should immediately schedule a vaccination or receive treatment. As suggested above, refusals of offered treatment and possible reasons for refusal may be monitored or attempts to reach a patient in a given demographic monitored to correlate the success rate of patient advertising or education programs such as HIV/AIDS prevention/treatment or anti-tobacco smoking campaigns.

Now, an exemplary mid-office management component 220 of FIG. 2 will be described in greater detail in FIG. 3 as mid-office management—electronic medical records component 300 comprising registry functionality 330-360 and a plurality of database 206 components which may comprise query filters 302-320: demographics 302, vitals 304, labs 306, ICD 308, CPT 310, prescriptions 312, alerts 314, medical history 316, immunizations 318 and encounters/visits 320. These filters should be considered exemplary and other names for similar filters may be used or additional filters employed and considered within the scope of the described embodiment. Each of these may be formulated on a display screen of a computer or work station or wireless device as a tab per the exemplary FIGS. 5-22. Each tab and its possible contents will now be discussed.

A demographics tab 302 provides query information about patient demographics contained in the practice's database 206. Demographics may be populated as discussed above by data transfer from another electronic medical records (EMR) system, by scoring a questionnaire, by interview or the like. If one wishes to omit a demographic category from a query, the field may be left blank. A first demographic may be age which may be specific, for example, 25, or be provided in an age range such as 20-29. A second demographic is sex: male, female or both may be possible choices. If a query is made to a database 206 for patients within different date ranges or of both sexes, entries may be separated by a comma to indicate a Boolean “OR” function. For example, a demographics query may query for patients as follows: M, F, 20-25, 60-65. Such a query returns patients that are both male and female between the ages of 20 and 25 and 60 and 65. A demographics query for: NOT 20-25, 60-65 would return all ages from 1-20, 26-60 and older than 65. A third demographic in the United States may be zip code (in addition to specific address data)—the zip code or postal code may in combination with other zip codes define a service region. A fourth demographic may be birth date which is practically an equivalent to age. As with age, the birth date may be equated to a range or to a term of art such as “baby-boomer”. Birth date is more specific than age and so is preferable as the record of “age” must be identified with a further date indicating, for example, the date the medical history was taken. A fifth demographic is insurance data which may be already known to the system 201 or entered, if unknown, via a text field. Similarly, a sixth demographic may be insurance group which is an identifier typically appearing on a patient's insurance card. If not known to the system 201, the insurance group code may be entered via a text field. A seventh demographic is the PCP, primary care provider. The PCP may already be known to system 201 and accessible via a more button or entered into a text field. An eighth demographic may be the identity of the referring provider 216 who likewise may be known to the system 201, accessible by a “more” button or added via a text field. A ninth demographic may be the identity of a facility such as an associated hospital which may be accessed from a drop-down menu and an authorized user selecting either facility or facility group or using the “more” button or adding an entry via a text field. A tenth demographic may be income level, typically not required but very useful for funded local, state and federal healthcare programs for monitoring the screening, prevention and treatment of the indigent or other uninsured (but not necessarily indigent) patients. A typical demographics query may be all patients over 65 years of age for a patient alert via patient portal 212 to receive a flu shot. Summary data may be reported to an insurance carrier of all patients covered by that carrier on a periodic basis. Summary data may be reported to a local, state or federal agency regarding treatment of the indigent, the uninsured, those receiving an experimental treatment or screening process and/or any other demographic groups of interest.

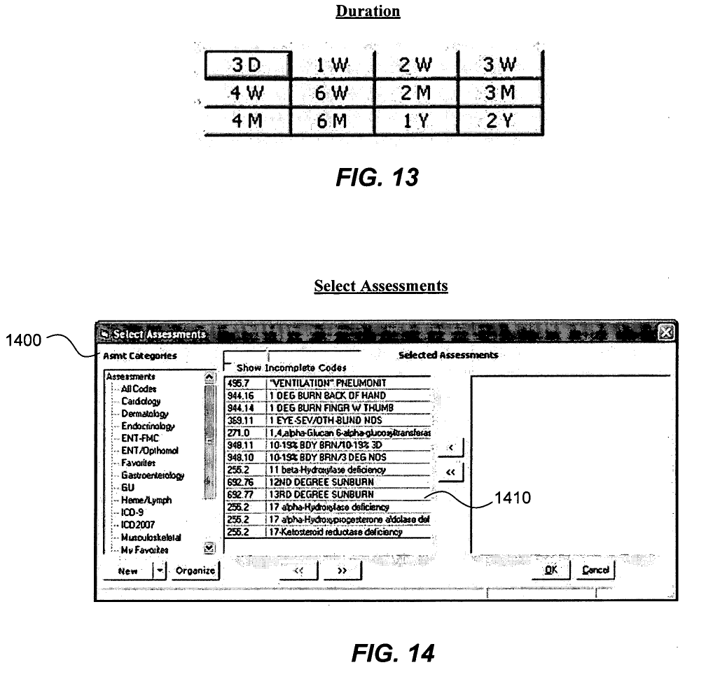

A vitals tab 304 may include, for example, the following data. A first vital may be height, a second weight, a third blood pressure and a fourth heart rate—all of these may be defined as a range or as an exact number and associated with a real time indication via clock 205. A fifth vital may be HC or head circumference as a specific or within a range. (HC is used in pediatrics to determine the progress of development of a child's brain.) A sixth vital may be body temperature which may be given as a specific value on a give date and time or as a range, such as normal. A seventh vital may be BMI or body mass index which can be a specific ratio or identified as a range between low and high. An eighth vital is a date range which can default to the current date. A start and end date can be edited. For example, a query may be constructed for a date range of the last five years while the BMI has exceeded a given value to identify patients that may need dietary advice and/or periodic cholesterol LDL checking and/or for a possible diabetic condition. See, for example, FIG. 13, for an example of a shorthand computer screen for entering dates and ranges such as 5 Y for 5 years. If a practice's database 206 is scheduled to update nightly at 11:00 PM, and a physician member of the practice would like to query the database and include the vitals information gathered from a patient earlier in the day, a migrate vitals button 501 may be provided to migrate current data for use in the query. FIG. 5 shows an exemplary migrate vitals button 501 in proximity to registry functions 502-505 to be described in greater detail later herein.

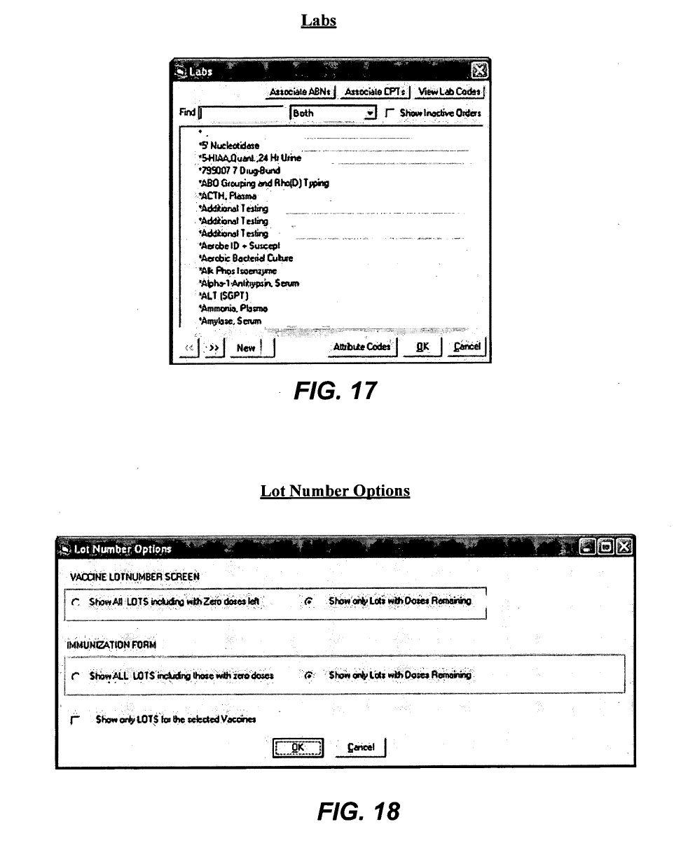

A laboratory tab 306 may be provided with a drop-down list of typical laboratories or a laboratory name may be entered into a labs text field. See FIG. 17 for a typical list of laboratories that may be provided via an exemplary display screen for computer selection. The labs tab allows users to query the database 206 for patients who have been given certain labs. For example, to find all patients with more than one instance of a particular lab (such as blood work for high cholesterol), one may enter a recurrence number in a number of labs field—such as 3 or more CBC (complete blood count) labs. One can also query, for example, labs within a specific date range or for all labs with certain results. See, for example, run new 505 and save queries 502 of FIG. 5 or FIG. 22. As discussed above, a Boolean “OR” function may be represented by a comma separating a sequence of entries; for example, for any of demographic, vitals or laboratory entries. For example, a blood test query may request the last three blood tests for PSA and cholesterol for a given patient where PSA and cholesterol are separated by a comma in a lab query. On a summary basis, data may be queried for percentages of patients who have a large BMI and a refusal to periodically check their cholesterol and why so that expenditures on a local, state, federal or insurance carrier funded education program can be correlated with success/failure rates of certain individuals accepting screening/laboratory testing. Another example may be funding of education programs for breast cancer screening, for example, via mammogram. The demographic profile for female and age group may be queried and a summary report prepared and reported without divulging patient name data for reporting to a cancer research agency of patient early warning success through treatment and data as to a percentage of females who refuse to be screened and why.

An ICD is a standard diagnostic code for the medical industry. FIG. 14 provides standard ICD codes for assessments. Per FIG. 14, if the physician searches a group such as cardiology category 1400, then, only cardiology assessments will be displayed. An ICD tab 308 may be provided for queries of a particular diagnosis. Because ICD is a standard, the ICD tab may be most easily provided via a drop-down list, for example, a list including third degree sunburn 1410. The corresponding assessment for the ICD selected may be displayed. The assessment may be entered via the screen of FIG. 6 at the time of consultation with a patient and input via a wireless LAN. Queries may be run for all patients having a given ICD diagnostic code among other queries. Alternatively, a drop-down list may provide an ICD group such as cardio to identify all heart patients as a group; see FIG. 16.

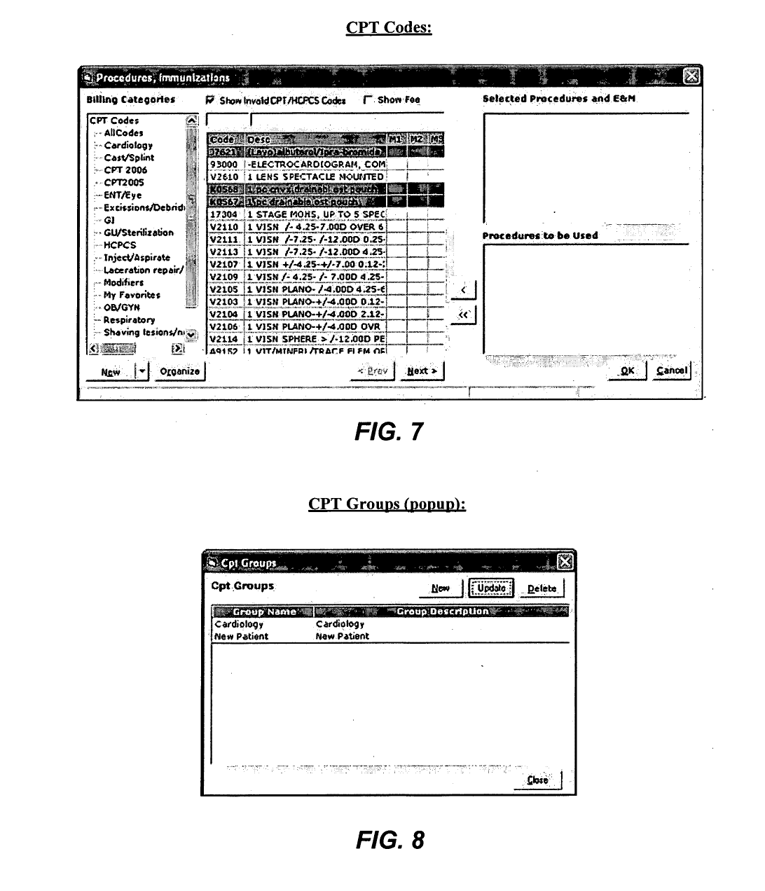

A CPT is a codified procedure term which typically applies to a given diagnosis. CPT codes tab 310 is most conveniently provided as a drop-down list; refer, for example, to FIG. 7 for an exemplary screen shot. Given a CPT code, a corresponding procedure/immunization window may display. Also, for each CPT, there may be a standard fee associated with the procedure and the fee associated with a billing category. Queries may be run for all children in need of a measles vaccination. Similarly to ICD's, CPT's may be provided in groups such as cardiology; refer to FIG. 8. Cardiology is first seen in FIG. 7 as a billing category and once selected, only cardiology CPT codes may be shown in a display window. FIG. 8 shows an association of a group such as cardiology to a new patient to be named. By entering “update” after the new patient's name is entered, the patient is labeled as a cardiology patient.

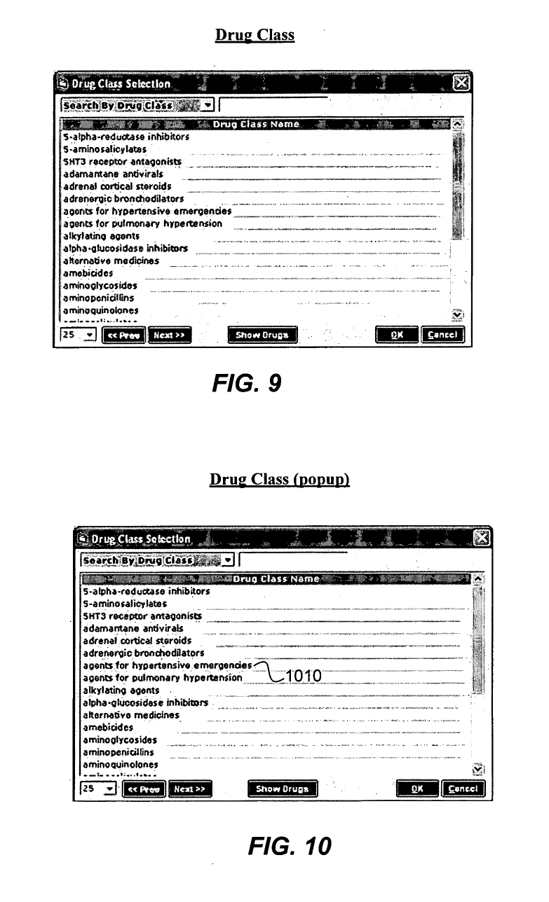

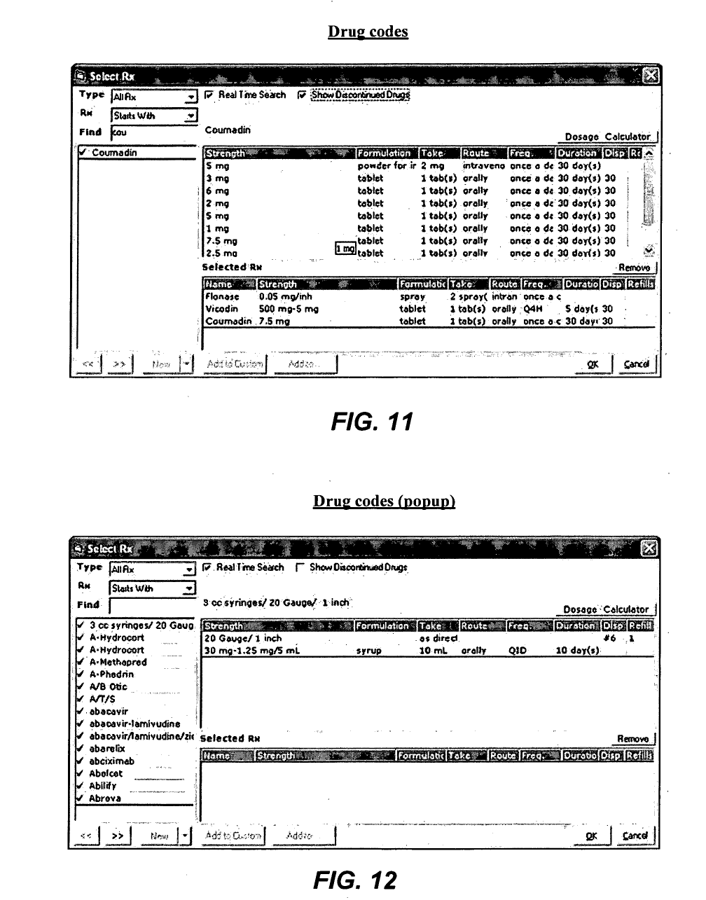

A Rx or prescription tab 312 is provided for standard drug types and name brand and generic identifiers as appropriate. The drug codes may be selected from a drop-down list by type, per exemplary screen shot FIG. 9, or “drug class.” Once a desired drug code is located and selected, for example, from FIG. 11 or 12, the various dosages and formulas related to the chosen category may be displayed. Discontinued drugs may be identified. Queries may be made for patients with prescriptions for a selected drug within a specific date range, for example, to find out what patients are currently taking a given medication. Using “run subset (not)” 503 diabetic patients over 65 not on insulin or using an insulin pump may be queried and identified. Besides drug codes, drug classes may be identified such as, for example, agents for hypertensive emergencies 1010. Thus, queries may be run by specific drug or by class as needed. A drug company may wish periodic reports on courses of treatment of an experimental drug in summary form without violating patient privacy. These may be provided by the registry feature of an embodiment on a monthly or quarterly basis.

An alerts tab 314 signals special situations known to the practice. Alerts may be categorized, then, as protocol alerts so that, for example, all patients given an immunization with treatable side effects may be identified and treated. One may search, for example, based on tests not ordered, tests not ordered and results not received and/or tests not ordered and results not reviewed. Queries may be constructed within date ranges per FIG. 13. As suggested before, summary data reports on health promotion, disease screening and prevention and related applications may be periodically provided to authorized users at varying levels of access rights.

A medical history tab 316 permits a query for patients with a specific medical condition (for example, an abnormal pap smear 2020). See FIG. 20 for an exemplary screen shot. A window may provide an alphabetical list of such conditions. One may scroll through the list and queries run to identify patients with the condition. Medical history may be displayed as selected for a given patient. A query may be run, for example, for just the word “pap” as needed to locate the desired condition using Find:. As indicated above, an agency or insurance carrier or research foundation may receive periodic reports or query the EMR system via an authorized user portal to obtain, for example, percentages of patients having regular pap smear testing and/or reasons for refusing such testing or reporting on the regularity of such testing over a time interval for all applicable patients.

An immunization tab 318 may not only contain a common identifier for an immunization such as small pox but also a lot number field to identify a lot used for an immunization in the event of a bad lot. Sequences of immunizations may comprise multiple lots. Lot information may be provided via exemplary screen shot FIG. 18, for example. In a disease prevention plan, summary data may be periodically transmitted to an agency or insurance carrier or the like providing percentages of patients applicable to the immunization plan such as polio, the course of treatments, and successful completion including whether a given patient ever contracts the given disease such as polio during their history. As before, the summary data may include data as to refusal or generally not showing up on scheduled dates for immunization. For example, immunization of an elderly demographic for flu and refusal or incapacity to show, for example, due to lack of transportation resources or immobility for other reason such as wheelchair or bed-ridden situations can be identified and reported so that local, state or federal or other relief may be found to overcome a given difficulty.

An encounters/visits tab 320 permits querying for patients based on encounters/visits dates. A quick date feature may be provided, for example, using shorthand such as 3 D for 3 days, or 5 W for five weeks or 8 M for eight months and 5 Y for five years. See exemplary screen shot for FIG. 13. One may query for only office visits and encounters may include recorded telephone calls. The encounters/visits tab may further permit querying for doctor house visits as an encounter outside the office or other encounter or meeting outside a medical or care facility such as at a hospice, crack house, hotel or other encounter.

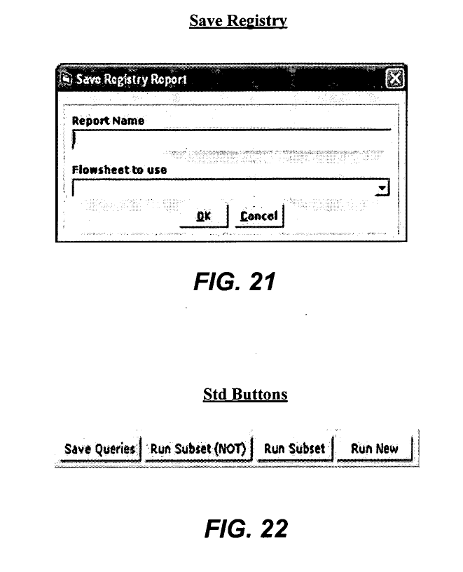

Now the registry functionality will be described comprising: save queries 330, run subset 340, run subset (not) 350 and run new 360 with reference to FIG. 3 and buttons of FIG. 5 or 22. Once a given query is run using a given filter, a save queries 330 function permits one to save a registry report (FIG. 21, for example) with a report name and a flowsheet to use from a drop-down list to select from. Once the Save registry report window of exemplary FIG. 21 displays, one selects the name and flowsheet and may click ok to save the query set. The new report is saved in a registry reports list and may be recalled by clicking an appropriate icon under, for example, a recalls band in a navigation bar for registry reports. See, for example, screen shot 21 for saving a registry report. For example, one may run a given report as an Excel® spreadsheet, and a file created as a comma-separated value (.csv) file.

Thus “save queries” 502 may save all current selections on all filters 302-320 across all tabs. The user may save their query set, name it, and attach a relevant flowsheet. The query may be run again in the future, for example, after a period of time. Run subset 340 (button 504) runs a query on a subset of a previous query using the information selected in the filters on that specific tab. For example, a first query may identify all patients over 65 and a second query may identify those that have had their flu shot. A run subset (not) 350 (button 503) will identify those patients over 65 who have not had their flu shot. Run new 360 runs a new query on the entire database 206 using selected filter options.

Thus, the running of queries may be seen as a set of Boolean operations, especially AND and NOT which may be performed to sequentially identify a population of patients who may be alerted by means of conventional telecommunications, by letter or by patient portal 212 to a need for an appointment, an appointment reminder, a medical alert, an upcoming laboratory or imagery requirement, a course of treatment or remedial efforts.

In one embodiment, via an authorized user portal, an authorized user may request a periodic query for disease prevention and screening applications. As suggested above, the funding of education programs may be correlated with specific preventative programs and the like. In one embodiment, a physician group or hospital may receive feedback from a central site as to how they rank with respect to other groups similarly situated in providing disease prevention and screening to specific demographic groups such as the uninsured and indigent. For example, the percentage of HIV positive patients in a national norm can be compared to local demographics and treatment/education plans designed and targeted for troubled geographic areas, for example, within a city. Similarly, drug, tobacco and alcohol dependency treatment and education plans may be targeted for specific demographic and geographic, physician group/hospital implementation where a central site recognizes a greater need in such an environment than a national norm.

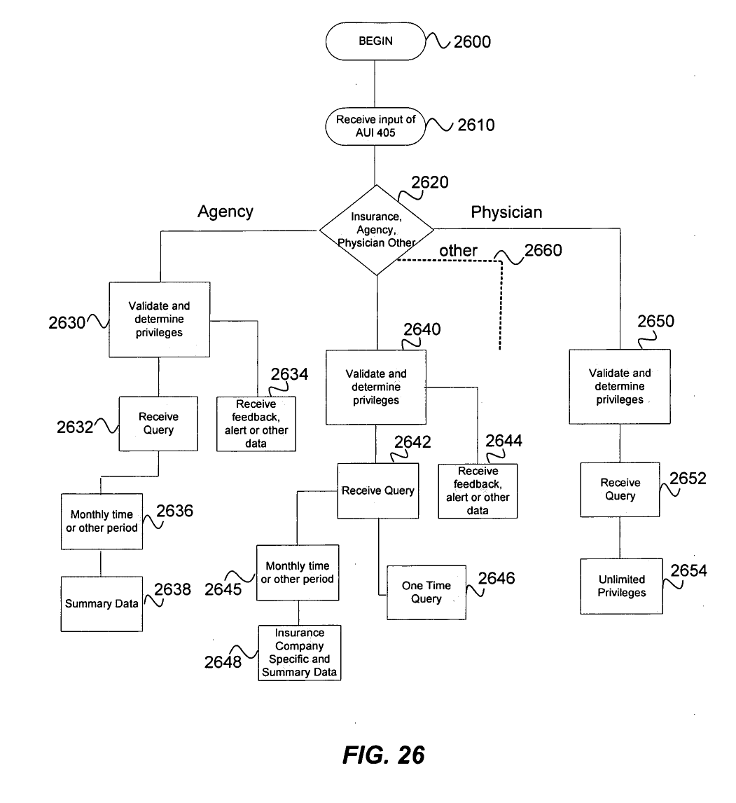

Now, FIG. 4 will be described in the context of the application of a registry feature of an embodiment of a medical records system 201. Box 400 may represent an electronic medical records (EMR) system registry module as described in accordance with FIG. 3. Box 405 represents a secure access portal for remote access to the registry feature 400. For example, typically, a physician may gain access to the registry feature and associated computer software application via the authorized user portal 405. However, in this embodiment, shared access is permitted to certain authorized agencies, universities, and the like. In principal, any of the entities depicted in FIG. 2 may be granted access and assigned privileges to access certain modules or access patient database 206 and, in the case of a physician, for example, actually change or update a patient's records remotely. A method of authorized user access, privilege assignment according to category of user and discussion of different queries and data input opportunities will be further discussed below in connection with a discussion of FIG. 26 and the following examples of categorical access to an EMR system via an authorized user portal 405. For example, an insurance carrier may be given access to records of their insured patients; a laboratory may be granted access to their laboratory results for patients they service and to upload new results into the patient database; an image (MRI, X-ray) location may be granted access to images prepared by them in the past and add new images. A pharmacist may be granted access via portal 405 to request prescription refills, determine patient status, query for prescriptions and alert as to unhealthy mixes of prescriptions for a given patient. A referring physician may be granted complete access to their patient's records and the like. A local, state or federal agency may be given access to summary reports for assessment of disease prevention and screening applications and to assess the success of education campaigns. Each of these may be given different passwords and keys for entry at different levels of security; each may be granted different privileges of access and reading/writing records into database 206 and each may receive data via unencrypted or, in another extreme, three-key encrypted access to data transmission of extremely sensitive patient data.

Box 410, for example, represents a plurality of federal agencies that may be interested in registry functionality. A Center for Disease Control (CDC) 410 a United States federal agency, may request and be provided access to the registry application and remotely use the application to query over a secure communications link the patient database 206 at one or more different remote locations. The results of a series of queries, for example, may be helpful to identify the outbreak of an epidemic in a geographic region of the country. A typical query might comprise all demographics, recent visits and exhibiting certain symptoms typical of the aviary flu. A city such as San Francisco may be interested in monitoring EMR databases throughout the city for certain demographics or symptoms or vitals for health promotion, disease prevention and screening and monitoring course of treatments and care as well as education programs, for example, promoting use of condoms in the prevention of AIDS or the treatment of additions such as tobacco, alcohol and drug. The result of querying an area such as San Francisco and a plurality of hospitals and physician groups equipped with the registry feature may suggest the outbreak of a bird flu epidemic. Conversely, the CDC or city may want to use the communications link to advise a practice of the outbreak of an epidemic and alerts as to the availability of immunization, for example, in the instance of an outbreak in the United States of the aviary flu and the availability/delivery of an associated vaccine. Via the patient portal 212 or other patient access such as conventional telecommunications access 214, the patients may be advised of the epidemic breakout, the availability of vaccine and the need to make an appointment with the practice group processing EMR software/hardware system 201 that has been alerted over the link. The course of treatment and success or lack of success of the treatment may be monitored by periodic summary data reports to the CDC, city or other authorized user. Physician groups and hospitals may receive feedback about their progress in controlling an aviary flu epidemic compared to a national norm and advised of measures they may take to improve performance if a defect in performance is identified. For example, funding may be provided for home visits so that more handicapped, immobile or bed-ridden patients may be vaccinated. Further details of such a scenario will be discussed subsequently herein with reference to FIG. 4 and FIGS. 23-25.

A National Institutes of Health (also identified in box 410 as a federal agency) may be interested in a pattern of increase/decrease in a given disease such as cardiac disease or cancer or AIDS. At the state level, for example, the state of Arizona, may be interested in demonstrating that the incidence of asthma or allergies and nasal congestion symptoms may be minimized if one lives in the state of Arizona. Weather and pollen count may be correlated with conditions such as asthma in a given geographical region and screening, education and treatment plans prepared accordingly and monitored from a central site. Private research organizations 430 and universities, medical colleges and the like may be interested in collecting data from databases 206 for research purposes. Such research groups may wish to identify patients with certain demographics or other characteristics and invite those participants to participate in research projects or try new courses of treatment or drugs under development. Progress of new experimental courses of treatment may be monitored as a periodic automatic query of each database 206 and a summary data report output by a secure communications link. Alternatively, the authorized user portal 405 may be used to access such summary data or start the automatic reporting of summary data with the requisite permissions within the bounds of patient privacy and security. These are but a sampling of the possible applications of a registry module of an embodiment of an electronic medical records system 201 as described above and an authorized user portal 405 to such a registry feature for disease prevention, screening, course of treatment monitoring and patient education purposes. Also, a given physician or physician group may receive alerts, feedback of their progress and suggestions for improvements to their practices when compared to other physicians similarly situated.

Another example might be the monitoring of levels of sugar in the blood of demographically applicable candidates for diabetes screening and education. If a high incidence of diabetes is discovered in a given area or with a given demographic the area or demographic may be educated or warned and requested to have their blood tested. Glucose/insulin may be ordered depending on results at a national, state, local or physician group level if percentages of patients with symptoms of diabetes exceed a predetermined level.

Now, one application of an enhanced electronic medical records system further including a control module will be discussed with reference to FIGS. 4 and 23-25 of a centralized mining of a plurality of remote databases of EMR subsystems. FIG. 4 shows a number of federal agencies 410, a number of state medical organizations, universities and the like 420 and private research organizations 430 seeking access to an EMR registry module 400 via authorized user portal 405. Consider a plurality of such remote registry feature sites. In many instances, there may be a need for such organizations to become authorized users and contact, poll or establish periodic summary data reporting on a real-time basis of a plurality of EMR registry modules 400 to obtain information about potential victims of an epidemic or catastrophe in advance, to reduce traffic flow, or upon their recognition of the event of an epidemic or catastrophe. For example, there may be a case when a plane has crashed, there is a major fire disaster in a high rise building or other similar catastrophe has occurred within a given geographical area (including the bird flu epidemic and other examples suggested above) requiring collection of registry data for a potential victim pool of individuals known to the centralized agency.

Referring to FIG. 23, there is shown a locus of catastrophe 2300, for example, a plane crash, a fire, a poisonous gas leak, the first occurrence of diagnosed cases of epidemic proportions or other locus of catastrophe that may have a confined or represent a zone of impact that may increase in size, for example, as a contagious disease spreads. A catastrophe is not limited to the spread of disease. For example, a forest fire may spread to an ever increasing area impacted by the fire depending on the weather and threaten residents with the likely outcome of an increase in burn victims, smoke inhalation and the like. A flood zone may be another example of a locus of catastrophe 2300 with a population threatened by drowning deaths, hyperthermia and the like. Then, 2310a and 2310b may denote entities of first response to the locus of catastrophe 2300 denoted with an E to indicate their emergency assistance status. Such entities may comprise first aid squads, fire fighters, rescue squads, ambulance services, police department quarters, the National Guard or locations of other emergency response personnel located within a concentrically increasing circular area around the locus of catastrophe 2300. Surrounding entities of first response 2310a and 2310b may be located homes of respective rescue squad members, police personnel, fire fighters and other emergency personnel.

Reference numerals 2320a and 2320b may denote locations of assistance such as large physician groups or hospitals with the resources to treat victims of the catastrophe positioned in the vicinity of the locus of catastrophe 2300. These are denoted H to signify their ability, for example, to provide hospital services. Surrounding locations of assistance 2320a and 2320b may be homes or residences or businesses of physicians, nurses and other personnel, typically, employees of the hospitals and physician groups.

Reference numerals 2330a and 2330b may denote locations of laboratory facilities and medical imaging functionality or other resources which may be useful in diagnosis as necessary for assisting locations of assistance 2320a and 2320b. These will be denoted R for resources. As already indicated for entities E and H, employees of resources R may be located proximate to their respective resource locations.

Finally, consider sources of medications denoted D (drugs), 2340a and 2340b, which may be pharmacies, pharmaceutical manufacturers or other sources of medicines and/or vaccinations. There also may be a plurality of locations where remains may be gathered denoted M (for example, morgues) of victims of the catastrophe who have lost their lives, 2350a and 2350b.

Now consider one or more centralized control locations C, 2360a and 2360b, which may be a state, city or federal agency and a communications network coupling such locations as E, H, R, D and M depending on the scope of the catastrophe. The communications network may be any network available and not impacted by disaster, wireless or wired, data, voice or video, slow or high speed. Each of entities C and H may maintain software according to and as described per FIGS. 1-22 and patient databases which require periodic update. It is anticipated that other entities such as E, R, D and M may also have authorized user portals to application software and databases for providing access by entities C to collect information as well as perform control functions such as load-balancing. For example, a location E of a rescue squad may maintain an accessible database indicating total resources available such as numbers and capacities of ambulances and other first aid vehicles, their capacities and the like as well as their real-time availability. In the event of a flood, school buses and personnel and other high capacity people moving vehicles including tractor trailers and trains/planes may be included for evacuation purposes. The morgue locations M may indicate their respective capacities and utilization. The drug companies and druggists D may maintain accessible databases for available drugs and quantities. Laboratory resources R may indicate capacities, utilization and data such as laboratory turn-around time for analysis of samples, imaging and the like.

The centralized control location C, 2360a and/or 2360b may comprise a large patient database 206 which may be periodically updated off-line in non-real time such as in non-busy hours between midnight and six in the morning by polling a plurality of associated patient databases at C (including other databases as described herein) and H for updates. Such updating is especially useful, for example, in a large metropolitan area for identifying all potential records of all potential victims in a given geographical area and for monitoring the servicing of victims by H. In the event of a catastrophe, entity C must quickly respond and involve all of entities E, H, R, D and M as required as well as respective personnel.

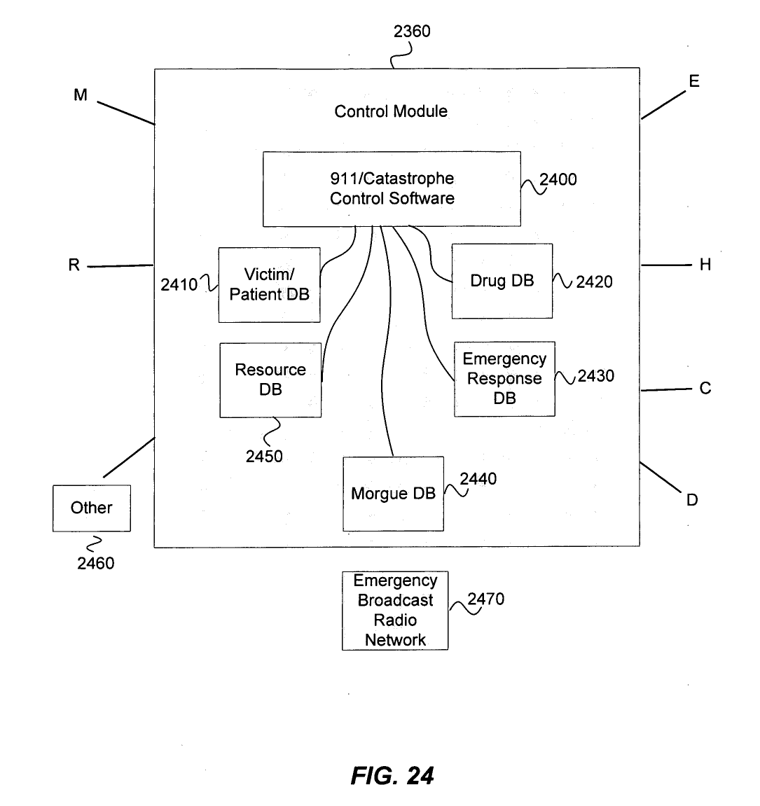

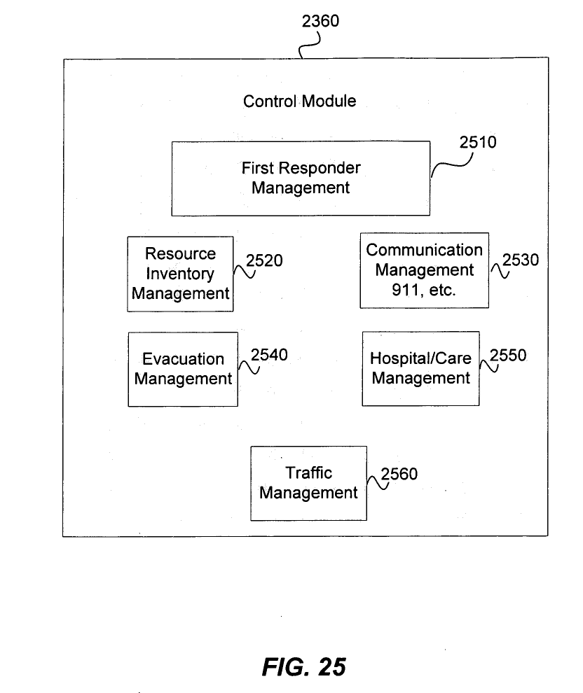

In the event of an emergency or catastrophe, the software system of FIGS. 1-3 is insufficient to meet the needs of a catastrophe at a control location C, 2360a and 2360b, and is further supplemented with a control module 2360 (per FIG. 24 and 25) which may be redundantly maintained at locations 2360a and 2360b with authorized user interfaces to the EMR software systems of entities C and H and similar interfaces to the capability and utilization databases of entities E, R, D and M. The control module, per FIG. 24 comprises a dial 911 emergency reporting module and control software status application 2400 (2530 of FIG. 25) and an associated first responder module (2510 of FIG. 25) in addition to the registry query features of FIGS. 1-22. Moreover, the control module 2360 must be in contact with other resources 2460 (FIG. 24) not shown in FIG. 23, for example, an airline in the event of a plane crash, to collect passenger information, or a corporate headquarters in the event of a major fire at a corporate high rise location to identify potential victims. The control module 2360 further includes a victim/patient database 2410 analogous to a patient database (not shown) which may include such detail as demographic data, vitals, history and other personal data that may be collected from a victims' families to identify remains via DNA analysis at laboratory resources R and/or by means of personal items such as remnants of clothes collected at the locus of a catastrophe 2300 such as an airplane crash, flood or fire.

According to the embodiment of FIG. 23, for example, in the event of a fire in, for example, a large metropolitan area, a centralized control site C may, in response to an emergency 911 or other call alerting of the fire, dispatch first responders via first responder management software 2510 known in the art to a locus of catastrophe 2300 in a conventional manner considering traffic flow, determine the identity of potential victims via Other 2460, control the flow of ambulance traffic to and from the locus of catastrophe 2300 to hospitals H and balance victim delivery to hospital facilities H. Thereafter, the control module 2360 may control the provision of needed resources R via a resource database 2450 and the delivery of medications D via database 2420 to hospitals H. Also, and not necessarily in any predetermined sequence, the control module may monitor the identification and location of victims who are deceased at locations M and maintain a morgue database 2440 whereby DNA and clothing analysis may be performed to identify the remains at laboratories R, that analysis being maintained in resource database 2450. Laboratories R may also be involved in diagnosis, for example, by analyzing blood samples for signs of a flu virus or other means of determining the diagnosis of a disease. By subsequent polling of EMR subsystems of locations H, they may obtain an identity of survivors in database 2410 while at the same time, by monitoring M determine those who did not survive and identify others still missing and unaccounted for in database 2410. Finally, control site C may deliver messages to family members of the status of victims or potential victims as maintained in database 206 via remote patient portals 212 or other, more direct private communication channels. In another embodiment and, for example, in the event of the spread of an epidemic, real-time messages may be delivered to potential victims in the path of spread of an epidemic by email, patient portal 212 access, wireless telephone, radio station emergency broadcast network 2470 or other means available to control site C. The above description of a catastrophe an related utilization of a logical mining interface to remote databases via an authorized user portal is not deemed to be limiting to the examples given and applications may only by limited by the imagination of such a centralized control module and associated potential victim/patient database and other centralized databases.

FIG. 26 provides a flowchart for a method of providing authorized user access selectively to authorized users comprising physicians, agencies, insurance companies and others. As has been described above with respect to disease prevention, education, screening and emergency response services, access privileged may be assigned to different entities that may have access to the registry feature of an EMR software system and database. Step 2600 simply refers to a begin of a software module for an authorized user access portal 405. A portal 405 provides an interface screen whereby an unauthorized user may request permission to become an authorized user and submit a request for authorized access as is well known in the art generally of user interfaces. Once an unauthorized user is authorized, the authorized user is provided with a user name and at least one password and/or other sign-in validation data that may be required of them for security purposes. The present method of FIG. 26 assumes an authorized user approaching an interface screen accessed, for example, via the world wide web. The authorized user signs in and data is received via the screen at portal 405, step 2610. At step 2620, the user having signed in must be identified at step 2620 as to category of use, for example, insurance agency access, agency access (city, state, local or federal agency or research facility such as a university) and physician among other category of user (for example, drug company). Once a given category is identified, the program branches to a branch dependent on the category of user, for example, agency, insurance, physician and other.

First following the agency branch at step 2630, the agency is validated as to category and privileges associated with that category determined and or limited. In the particular case of an agency, two exemplary privileges are to construct a query at step 2632 as described above and to provide alerts (for example, a bird flu alert) or feedback as to how the physician group having the EMR system is doing in comparison with similarly situated groups and/or provide other data. At step 2632, the query is received but may be limited in scope to exclude patient-specific data, i.e. a patient's name. The query may be a one time query at step 2636, a monthly run query or run at another selected period of time at box 2636. Yet, at box 2638, only summary data is provided and not patient-specific data. For example, summary data for a specific income level of patient may be provided where the physicians' group receives subsidies for providing services to that income level of patient. At box 2634, for example, after analysis of summary data from other similarly situated physician groups, the agency may have the privilege of providing alerts such as bird flu alerts, feedback as to how the physicians' group is doing in comparison with others similarly situated and other data.

Once an insurance company category is validated at box 2640 and identified as a particular insurance company, certain different privileges associated with the category of insurance company may be determined. For example, the insurance company at box 2642 may determine a query for patient data for patients supported by that insurance carrier. The insurance carrier may construct a one time or periodic query associated with the privileges determined at step 2640. The insurance company specific summary data for their patients may then be reported in response to the one time or periodic query received at box 2642. At box 2644, the insurance company may register data specific to that insurance company such as copayment, levels of authorization for different policies or groups and may provide feedback on billing and treatment progress such as accepting or denying authorization for a given course of treatment due to its experimental nature.

Physicians may be given unlimited access to record and change a patient data base and retrieve information from the database at privilege determination step 2650. The physican may construct a query at box 2652 and receive unlimited privileges to operate remotely at box 2654 as discussed above. For example, the physician may remotely authorize a prescription request received from a requesting patient at a patient portal or, in an “encounter” with the patient, input information about the patient to the database.

An “other” category may comprise, for example, drug companies interested in outcomes of treatments using experimental drugs, patients seeking to gain access to their own records, make appointment or request prescriptions or other who may likewise be categorized and provided privileges to access and query the EMR database or provide inputs or requests or other data to the EMR database according to their assigned privileges, druggists, laboratories, imaging facilities and the like in accordance with discussions of examples provided above.

It should be understood that the medical arts should be defined to include the dental arts, the Chinese practice of medicine and other conventional and non-conventional forms of medicine practiced in the United States and throughout the world. Other advantages and features will come to mind of one of ordinary skill in the medical software arts from reading the disclosure of the embodiments and the embodiments should only be deemed limited by the scope of the claims that follow.

What I claim is:

1. A logical interface for mining medical data records comprising:
a data processor for receiving input of a selection of criteria for a medical records query;
a database of medical records, responsive to a Boolean query, for outputting patient medical record data responsive to the query, the Boolean query including one of a logical OR function and a logical AND function; and
a plurality of operations including a means of combining a first and second query and a means of providing medical data not meeting the first and second query, one of the first and second query including a logical NOT function.

2. A logical interface as recited in claim 1 further comprising a patient portal for access by patients, the patient portal for providing medical data to a patient responsive to the first and second query.

3. A logical interface as recited in claim 1 wherein said first or second query comprise querying via a plurality of filters including at least one of demographics, vitals and prescriptions.

4. A logical interface as recited in claim 1 wherein said first or second query comprise querying via a plurality of filters including at least one of prescriptions and immunizations.

5. A logical interface as recited in claim 1 wherein said first or second query comprise querying via a plurality of filters including at least one of an ICD code or a CPT code.

6. A logical interface as recited in claim 1 wherein said first or second query comprise querying via a plurality of filters including at least one of a medical history and encounters/visits.

7. A logical interface as recited in claim 1 further comprising an interface to an external database including one of a federal agency, a state agency and a research organization.

8. A logical interface as recited in claim 7 further comprising a patient portal for access by patients, the patient portal for providing a medical alert input via said interface to an external database.

9. A logical interface as recited in claim 1 wherein said logical OR function is indicated by separating query entries by a comma.

10. A logical interface as recited in claim 1 further comprising an authorized user portal, the authorized user portal providing different levels of secured access, different privileges to access and modify patient record information and different output data transmission encryption requirements for different authorized users of the logical interface.

11. A method of logically interfacing with a medical records database comprising:
selecting a first query via a first filter;
selecting a second query via a second filter;
running a subset combining the first and second queries; a query comprising one of the Boolean logic OR and AND functions; and
logically “not” operating on the subset to obtain a set of medical patient data from the medical records database.

12. A method of logically interfacing as recited in claim 11 further comprising:
transmitting a message associated with the set of medical patient data via a patient portal.

13. A method of logical interfacing as recited in claim 11 wherein said first or second query comprise querying via a plurality of filters including at least one of demographics, vitals and prescriptions.

14. A method of logical interfacing as recited in claim 11 wherein said first or second query comprise querying via a plurality of filters including at least one of prescriptions and immunizations.

15. A method of logical interfacing as recited in claim 11 wherein said first or second query comprise querying via a plurality of filters including at least one of an ICD code or a CPT code.

16. A method of logical interfacing as recited in claim 11 wherein said first or second query comprise querying via a plurality of filters including at least one of a medical history and encounters/visits.

17. A method of logical interfacing as recited in claim 11 further comprising interfacing to an external database including one of a federal agency, a state agency and a research organization.

18. Computer readable media for performing the method of claim 11.

19. A system comprising an electronic medical records subsystem and a centralized database, the centralized database collecting medical query result data from at least one subsystem, the centralized database for permitting the generation of a medical alert directed to patients associated with the medical records subsystem, the centralized database further including a control module, the control module responsive to an emergency call alerting first responder to the emergency.

20. A system as recited in claim 19 further comprising a patient portal of the electronic records subsystem for providing a personal patient alert.

21. A system as recited in claim 20, the centralized database for periodically polling a plurality of electronic medical records subsystems for maintaining a patient database of patient size greater than that of one electronic medical records subsystem, the centralized database further comprising a communications link for receiving potential victim data and further comprising a victim database in addition to said patient database.

22. A system as recited in claim 21, the centralized database having communications links to first responders, hospitals, medication providers, laboratory resources and morgues, the system, responsive to a reported catastrophe, balancing delivery of victims to hospitals by ambulances.

23. A system as recited in claim 21, the centralized database having logical software for developing identities of deceased victims, hospitalized victims and unaccounted for potential victims.

24. A method for providing query and data input privileges at a remote user interface to an electronic medical records system where the remote users are categorized among physician, insurance company and agency, the method comprising
validating user input and determining a category of user privileges selected from the categories of physician, insurance company and agency,
if insurance company, providing query privileges for constructing a query for data for patients insured by the insurance company and input privileges for changing billing and payment practices for a given patient depending on a policy level,
if physician, providing a query privilege for constructing a query for data for a patient or group of patients of the electronic medical records system and providing said physician with input privileges including changing patient treatment data and inputting encounter data, and
if agency, providing a query privilege for constructing a query for summary data of a given level of income exclusive of individual patient identity and providing said agency with privileges of inputting one of medical alert and feedback to the electronic medical records system of treatment success in comparison with other electronic medical records systems having similarly situated patients.
